(19) United States
(12) Patent Application Publication
(10) Pub. No.: US 2002/0072917 A1
(43) Pub. Date: Jun. 13, 2002

(54) Method and apparatus for speech recognition incorporating location information

(76) Inventors: David Rand Irvin, Raleigh, NC (US); Thomas M. Croft, Cary, NC (US)

Correspondence Address: COATS & BENNETT, PLLC, P O BOX 5, RALEIGH, NC, 27602, US

(21) Appl. No.: 09/734,289

(22) Filed: Dec. 11, 2000

(51) Int. Cl. G10L 21/00; G10L 11/00

(52) U.S. Cl. 704/270.1

(57) ABSTRACT

A method and apparatus for speech recognition incorporating location information. The method comprises receiving voice input from a user, associating a confidence measure with each of a set of stored patterns according to how closely the stored pattern matches the voice input, acquiring location information, and modifying one or more of the confidence measures based upon the location information. The apparatus comprises a speech recognition circuit that provides confidence measures, circuitry for acquiring location information, and logic for modifying the confidence measures based on the location information. Exemplary applications such as voice-dialing in a mobile communication device are described.

### BACKGROUND OF THE INVENTION

The present invention relates generally to the field of speech recognition and, more particularly, to a method for improving the likelihood that voice input to a speech recognizer is correctly recognized.

Speech recognizers are used in a variety of applications. One exemplary application is voice-dialing in communication devices such as cellular phones. Voice-dialing allows a user to speak a label such as “Robert” to dial a corresponding telephone number, saving the user the time and effort to key in the telephone number one digit at a time. In typical voice-dialing implementations, the communication device accesses a stored directory comprising patterns representing spoken labels and their corresponding telephone numbers. When the user says a particular label, the voice input is processed to produce a pattern representing the voice input. This pattern is compared to each of the stored patterns in the directory, and a confidence score is returned for each pattern indicating the likelihood that the voice input corresponds to that particular pattern and, hence, the associated label. If the voice input is not recognized correctly, an incorrect number may be dialed, embarrassing or inconveniencing the user. Therefore, there is a need for methods of increasing the likelihood that the correct number will be dialed.

### SUMMARY OF THE INVENTION

A method and apparatus are provided for speech recognition incorporating location information.

The method comprises receiving voice input from a user, associating a confidence measure with each of a set of stored patterns according to how closely the stored pattern matches the voice input, acquiring location information, and modifying one or more of the confidence measures based upon the location information.

The apparatus comprises a speech recognition circuit that provides confidence measures, circuitry for acquiring location information, and logic for modifying the confidence measures based on the location information.

In one embodiment, the invention improves the performance of voice-dialing in a mobile communication device.

### BRIEF DESCRIPTION OF THE DRAWINGS

FIG. 1a is a functional block diagram of an environment of the invention.

FIG. 1b is a functional block diagram of a mobile communication device in which voice-dialing may be implemented.

FIG. 2 is a flowchart illustrating the general operation of the invention in a voice-dialing application.

FIG. 3 is a flowchart illustrating the operation of an aspect of the invention.

FIG. 4 is a flowchart illustrating the operation of another aspect of the invention.

FIG. 5 is an exemplary table illustrating a record of previous telephone calls in accordance with yet another aspect of the invention.

FIG. 6 is a flowchart illustrating the operation of yet another aspect of the invention that uses the kind of information illustrated in FIG. 5.

FIG. 7 is a flowchart illustrating the operation of a further aspect of the invention.

FIG. 8 is an exemplary table illustrating stored patterns and their corresponding confidence measures before being modified.

FIG. 9 is an exemplary table illustrating stored patterns and their corresponding confidence measures after modification by the invention.

### DETAILED DESCRIPTION OF THE INVENTION

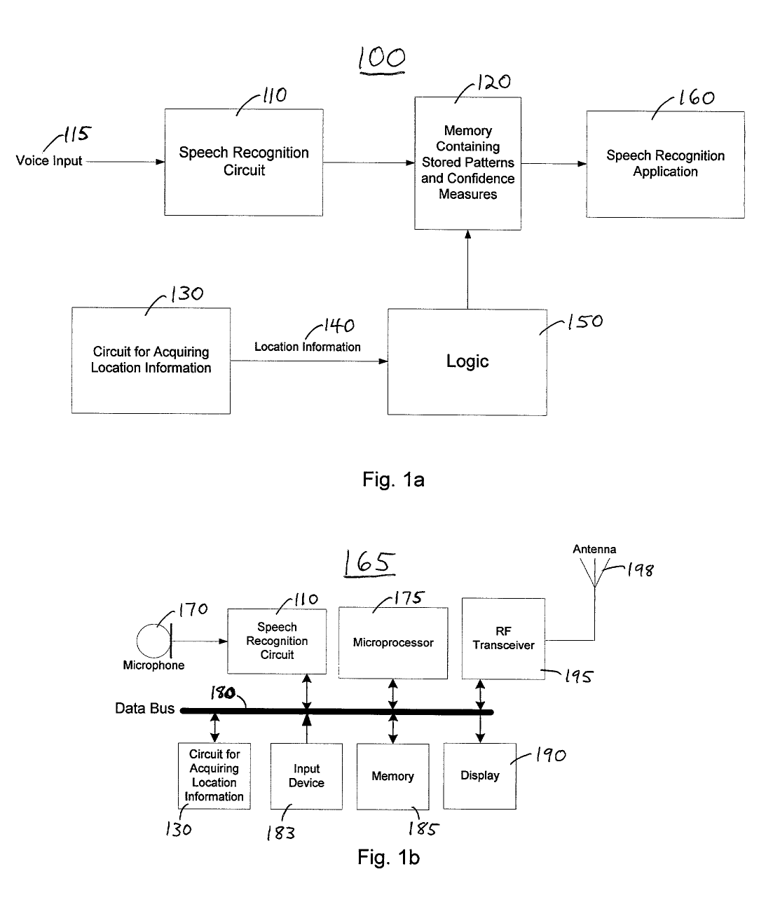

The invention operates within an environment 100 such as that shown in FIG. 1a. A speech recognition circuit 110 receives voice input 115, processes it to produce a pattern representing voice input 115, compares the pattern to each of a set of patterns stored in memory 120, produces a confidence measure for each stored pattern, and stores the confidence measures in memory 120. A confidence measure is a numeric indication of the degree to which the pattern representing voice input 115 matches the associated stored pattern. Those skilled in the art will recognize that it is convenient to express a confidence measure as a percentage or a number between 0 and 1, inclusive. A circuit for acquiring location information 130 outputs location information 140 to logic 150. The circuit 130 for acquiring location information may comprise a Global Positioning System (GPS) receiver. Circuit 130 may alternatively use techniques such as terrestrial cellular positioning or coarse positioning using the base station identification codes of one or more base stations, all of which are known in the applicable art. In some applications, circuit 130 may use exchange codes, area codes, or country codes included in telephone numbers as proxy for more precise location information. Logic 150 modifies the confidence measures in memory 120 in accordance with location information 140. The modified confidence measures in memory 120 may then be used for decision making by a suitable speech recognition application 160.

For most of the remainder of this description, the invention is described within the context of an exemplary application, namely voice-dialing in a mobile communication device such as a cellular telephone, Personal Communication System (PCS) telephone, satellite telephone, cordless telephone, pager, personal digital assistant, or communicator. In the voice-dialing application to be described, the environment 100, therefore, is part of a mobile communication device 165, for which a functional block diagram is shown in FIG. 1b. Mobile communication device 165 comprises a microphone 170 and microprocessor 175, which communicates over data bus 180 with circuit 130, speech recognition circuit 110, input device 183, memory 185, display 190, and RF transceiver 195. RF transceiver 195 is electrically connected to antenna 198. Although the invention is described primarily in terms of voice-dialing in mobile communication device 165, the invention applies to any situation in which speech recognition may be aided by location information and is not limited to the voice-dialing application.

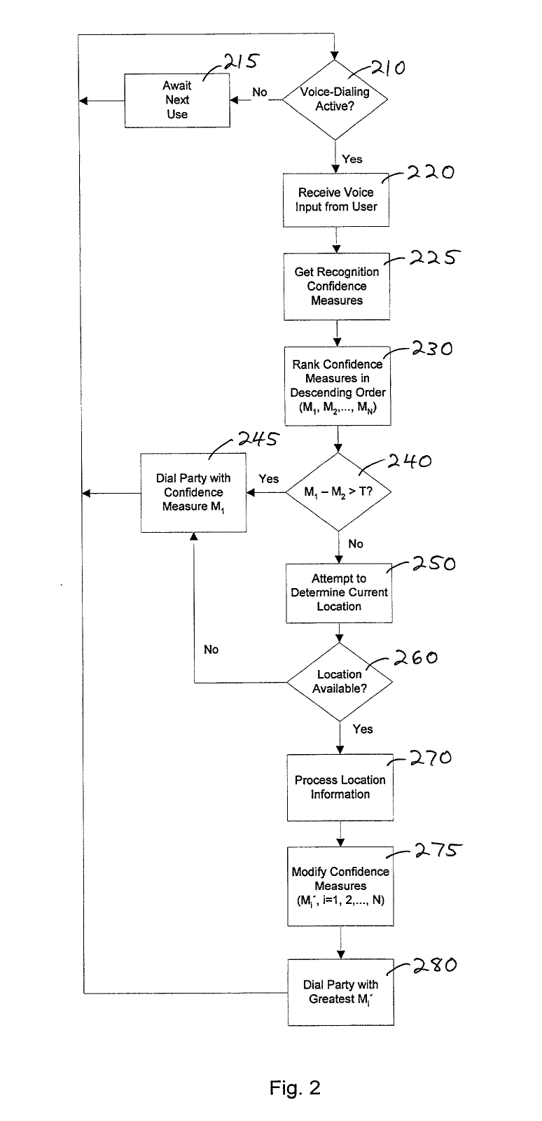

FIG. 2 is a flowchart of the general operation of the invention in a voice-dialing application within a mobile communication device 165. At 210, microprocessor 175 determines whether the voice-dialing function has been activated. For example, the user may activate voice-dialing via input device 183, which may comprise a keypad. If voice-dialing has not been activated, its next use is awaited at 215. Once voice-dialing has been activated, voice input 115 from a user is accepted at 220. Voice input 115 comprises a spoken label that the user has previously associated with a telephone number to be dialed. The label may comprise a word, name, phrase, nickname, or other utterance appropriate for the type of speech recognition technology employed. After receiving voice input 115, speech recognition circuit 110, according to methods known in the applicable art, processes voice input 115 to produce a pattern representing voice input 115. Speech recognition circuit 110 compares the pattern representing voice input 115 with each of a set of stored patterns, each of which in turn corresponds to a stored telephone number, and returns a confidence measure for each pattern at 225. The confidence measures are optionally ranked from greatest to smallest at 230. Although those skilled in the art will recognize that ranking the confidence measures at 230 is not essential, doing so simplifies the notation in the description of the next few steps and has been included in FIG. 2 for that purpose. Therefore, without loss of generality, let the ranked confidence measures, in descending order, be denoted as M₁ through M_{N}, respectively. At 240, the difference between the greatest and next-to-greatest confidence measures, M₁ and M₂, is computed. If the difference exceeds a predetermined threshold T, the decision is assumed to be unambiguous, and the party corresponding to confidence measure M₁ is dialed at 245. If the difference at 240 does not exceed T, an ambiguous situation occurs, and circuit 130 attempts to determine the current location of environment 100 at 250. If the current location of mobile communication device 165 is not available at 260, the party corresponding to confidence measure M₁ is dialed. Otherwise, location information 140 is fed to logic 150 at 270. According to various aspects of the invention to be described more fully in subsequent portions of this description, the confidence measures are modified at 275 in accordance with location information 140 to produce the confidence measures denoted M₁ through M′_{N}. At 280, the party with the largest modified confidence measure is dialed.

In one variation of the general operation depicted in FIG. 2, location information 140 is acquired unconditionally, and the confidence measures are modified based on location information 140 regardless of whether or not an ambiguous situation occurs. Therefore, in such a variation, it is not necessary to compute the difference between the greatest and next-to-greatest confidence measures, M₁ and M₂, before carrying out steps 270 and 275. As in the foregoing explanation of FIG. 2, ranking the confidence measures at 230 is not essential.

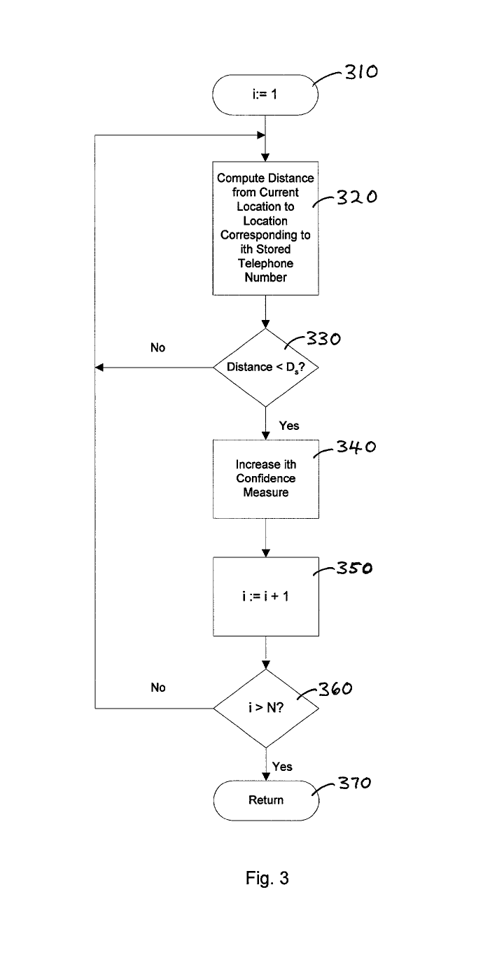

The flowchart of FIG. 3 shows the operation of one aspect of the invention, more particularly an implementation of steps 270 and 275 in FIG. 2. This particular aspect employs distance between the called party and the current location of mobile communication device 165 as a criterion for modifying the confidence measures. In this aspect of the invention, the current location of mobile communication device 165 is assumed known from circuit 130. One method of determining the distance between mobile communication device 165 and a called party is to consult a look-up table mapping subparts of telephone numbers such as exchange codes, area codes, or country codes to their corresponding geographical regions. Once an approximate location corresponding to a stored telephone number is known, an approximate distance may be computed between mobile communication device 165 and the stored telephone number using a second look-up table containing distances between various geographical regions such as cities, towns, or metropolitan areas. One efficient method to implement this aspect of the invention is to store the approximate location corresponding to a stored telephone number in the same directory or database as the stored telephone numbers and their corresponding patterns. In FIG. 3, a counter is initialized at 310, and the distance between the current location of mobile communication device 165 and the telephone number associated with the first stored pattern is computed at 320. At 330, the distance is compared to a predetermined threshold Dₛ. For example, Dₛ might be 15 miles. If the distance is less than Dₛ, the confidence measure associated with the first stored pattern is increased at 340. For example, the confidence measure might be increased by 10 per cent when the distance is less than Dₛ and not increased when the distance is greater than or equal to Dₛ. Optionally, the confidence measure is instead decreased if the distance is greater than or equal to Dₛ and left unmodified if the distance is less than Dₛ. In yet another variation, the confidence measure is increased if the distance is less than Dₛ and decreased if the distance is greater than or equal to Dₛ. All of the foregoing variations of the modification at 340 have the effect of favoring, in the final selection of the number to be dialed at 280, those stored telephone numbers that are close to the current location of mobile communication device 165 over those that are more distant. At 350, the counter is incremented. Steps 320 through 350 are then repeated until the test at 360 determines that all stored patterns have been considered. At 370, control is returned to 280 in FIG. 2.

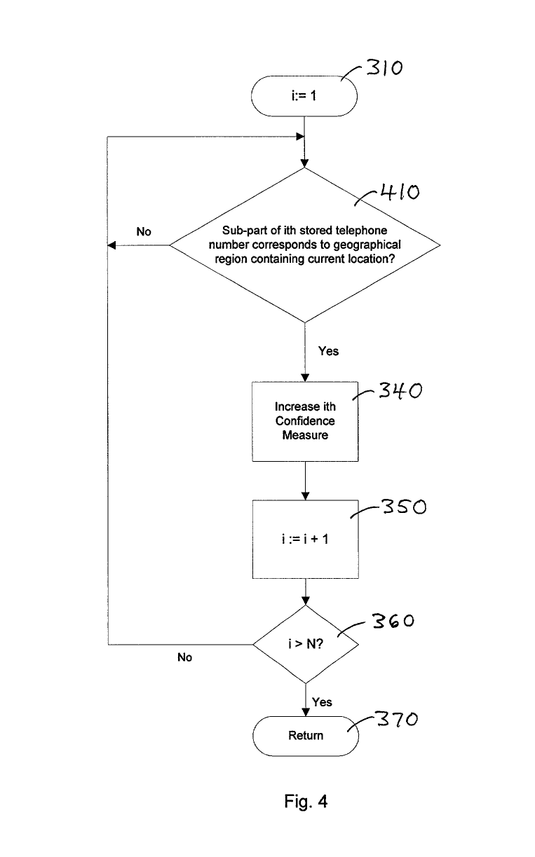

FIG. 4 illustrates the operation of another aspect of the invention, more particularly another implementation of steps 270 and 275 in FIG. 2. This aspect employs subparts of telephone numbers such as area codes, exchange codes, or country codes as a proxy for more precise location information in a different manner from the aspect shown in FIG. 3. FIG. 4 differs from FIG. 3 at 410, where a sub-part of the stored telephone number corresponding to each stored pattern is tested using a look-up table such as the one described in connection with FIG. 3 to determine whether or not the stored telephone number corresponds to a geographical region within which mobile communication device 165 lies. In this aspect of the invention, no distances are computed. The current location of mobile communication device 165 is assumed to be known to within the resolution of the applicable geographical region corresponding to the subpart of the stored telephone number being tested at 410. For example, the current location of mobile communication device 165 may be known to be within area code 919 based on terrestrial cellular positioning data obtained from circuit 130. In general, the geographical region may be that of a single area code, several area codes (a metropolitan area), the region served by an exchange code, or a country, depending on which sub-part is examined. Those skilled in the art will recognize that which sub-part to examine is a design choice that depends, at least in part, on the degree of granularity that can be tolerated in the geographical regions upon which the test at 410 is based. If a match occurs at 410, the associated confidence measure is modified as described in connection with FIG. 3. This aspect of the invention is intended to aid a user who travels frequently to one or more geographical regions. For example, a person traveling from Raleigh, N.C. to New York City and walking along a street within area code 212 would likely prefer that a telephone number with a label “Bob” located within New York City area code 646 be favored over another number with the same label located in Portland, Oreg. when an ambiguous situation occurs. Since some large metropolitan areas such as New York City have multiple area codes, the test at 410 uses a look-up table mapping area codes to cities to determine that the “Bob” who lives in area code 646 and the user are in the same metropolitan area.

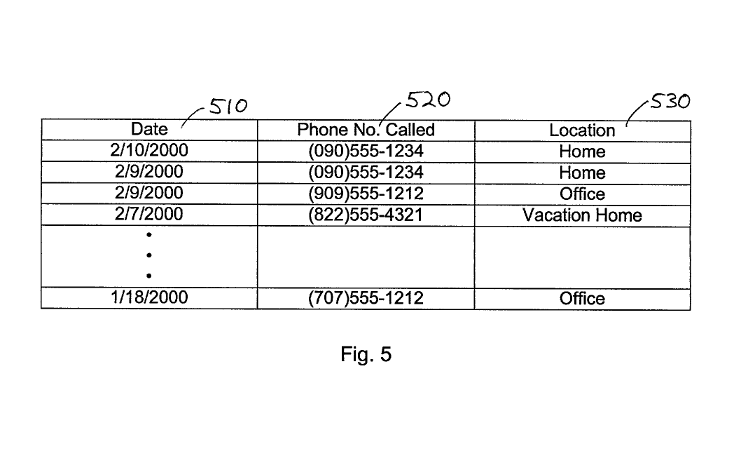

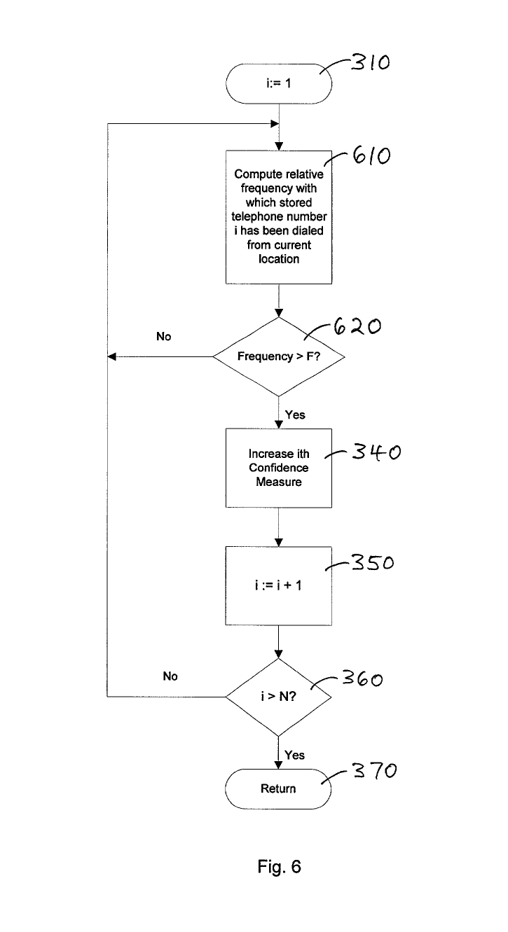

FIG. 5 is an exemplary table illustrating a record of previous telephone calls in accordance with yet another aspect of the invention, the operation of which is illustrated in FIG. 6. In FIG. 5, the left column 510 contains dates on which the out-going calls were placed using mobile communication device 165. The phone numbers dialed are contained in the center column 520. The right column 530 contains named locations such as “Home,” “Office,” or “Vacation Home” from which the calls were placed. The user defines the named locations by associating a name with geographical coordinates or other location information obtained from circuit 130. Mapping geographical coordinates to user-defined place names is known in the art and is described in more detail in U.S. Pat. No. 6,078,826, which is also assigned to Ericsson Inc.

FIG. 6 illustrates the operation of yet another aspect of the invention, more particularly an implementation of steps 270 and 275 in FIG. 2. When an ambiguous situation occurs, this aspect uses a call history record including correlated location information such as that shown in FIG. 5 to favor stored telephone numbers that have been called frequently from the current location of mobile communication device 165. FIG. 6 is much like FIG. 3, except that the relative frequency with which each stored telephone number has been called previously from the current location of mobile communication device 165 is computed at 610, and the computed relative frequency is compared to a threshold F at 620. The confidence measure is then modified in a manner analogous to that described in connection with FIG. 3, the difference being that the threshold is now one of frequency instead of distance. This aspect of the invention aids voice-dialing based on the assumption that many users tend to call a given stored telephone number from the same location much of the time. For example, a worker may call his spouse from the office frequently. Suppose the spouse's name is “Peggy” and that the worker has a head cold when he attempts to voice-dial from the office on a particular occasion, resulting in an ambiguous situation in which both “Peggy” and the worker's out-of-state sister “Penny” are assigned approximately the same confidence measure by the speech recognition circuit 110. The worker never calls his out-of-state sister from the office, so the aspect of the invention shown in FIG. 6 favors “Peggy” over “Penny” by increasing the confidence measure associated with “Peggy” relative to “Penny.”

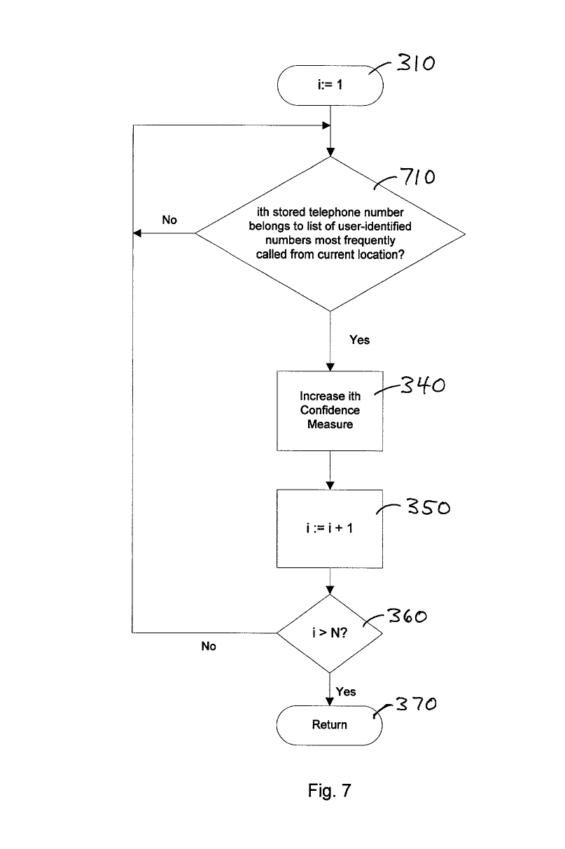

FIG. 7 illustrates the operation of a further aspect of the invention, more particularly an implementation of steps 270 and 275 in FIG. 2. In this aspect, which is related to the aspect shown in FIG. 6, the user defines a list of most frequently called telephone numbers for each of a set of named locations defined by the user. At 710, the stored telephone numbers corresponding to the stored patterns are compared to the stored list of most frequently called telephone numbers associated with the current location of mobile communication device 165. If the test at 710 determines that a stored telephone number matches one of the numbers on the list, the corresponding confidence measure is modified as described in connection with FIG. 3. One advantage of this approach is that the user may intervene to change the behavior of the invention when circumstances change suddenly, at the expense of some extra time spent in configuration. Further, this approach does not require the computation of relative frequencies, nor does it require a record of previous calls.

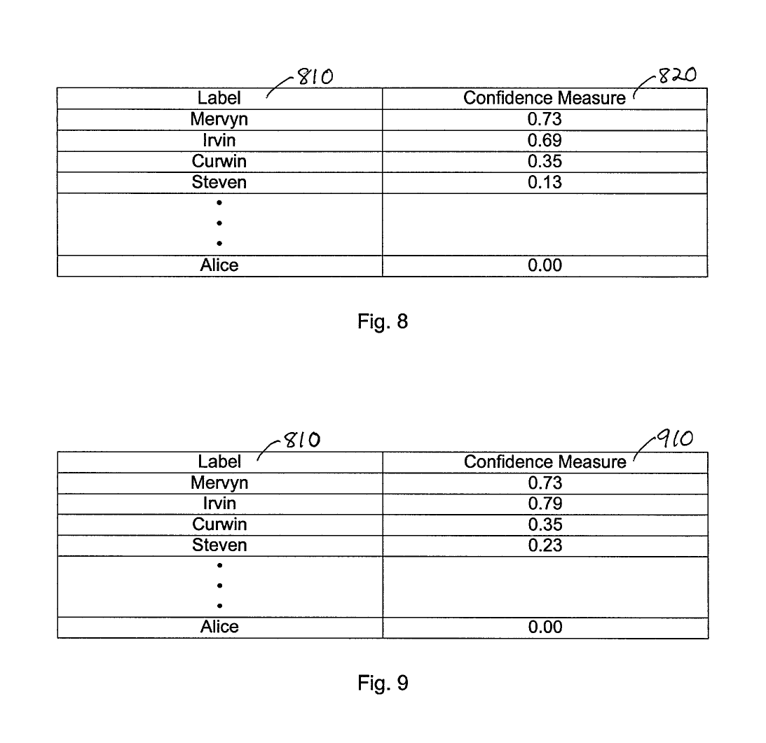

All of the foregoing aspects of the invention have the effect of modifying the confidence measures returned by speech recognition circuit 110 based on location information 140. An example of how this works in practice and how the dialing decision at 280 is affected is illustrated in FIGS. 8 and 9, in which a user has attempted to voice-dial his brother “Irvin” from the user's home. FIG. 8 shows exemplary labels 810 and their associated confidence measures 820 before being modified based on location information 140. The situation illustrated is ambiguous because the difference between the confidence measure associated with “Irvin” and a coworker named “Mervyn” is slight. In FIG. 9, after the confidence measures 820 have been modified based on location information 140, the confidence measures 910 associated with “Irvin” and a golf buddy named “Steven” have each been increased by 10 per cent because the user frequently calls these two individuals from home. In this example, “Irvin” would be dialed instead of “Mervyn” because “Irvin” now has the greatest confidence measure.

In other applications of the invention, the stored data corresponding to a stored pattern may be other than a telephone number. For example, the stored patterns may correspond to some other type of electronic address such as an e-mail address or Uniform Resource Locator (URL).

As an example of a different application of the invention, the aspect described in connection with FIG. 6 may be applied to a voice-driven e-mail client program running on mobile communication device 165. A voice-driven e-mail client allows a user to control its functions, at least in part, by speaking commands instead of using a keyboard or mouse, as is known in the art. For example, the user might be able to create a new message by saying “new” and address the message by saying a label such as “Julie.” As with voice-dialing, a problem arises if there are multiple people with the same label or if the speech recognizer assigns a nearly equal confidence measure to a pattern associated with a different label such as “Jerry.” In a manner similar to that illustrated in FIG. 5, a record may be kept of the user-defined, named locations such as “Home” or “Office” from which past e-mail messages have been sent from mobile communication device 165. When an ambiguous situation occurs, the confidence measures associated with e-mail addresses frequently contacted from the current named location of mobile communication device 165 are modified to favor the corresponding e-mail addresses over those less frequently contacted from that same location. For example, the user may frequently e-mail “Julie,” a neighborhood friend, from mobile communication device 165 while at home but almost never e-mail “Jerry,” a network support technician at the user's workplace, from that location. If speech recognition circuit 110 produces nearly equal confidence measures for the patterns corresponding to “Julie” and “Jerry,” the invention favors “Julie” based on the correlated location information contained in the record.

Yet another application for the invention is voice dictation, which allows a user to create or edit documents by speaking instead of typing. Based on the current location of mobile communication device 165, different recognition vocabularies may be favored. For example, if the user is at home, a particular household vocabulary is more likely than when the user is at the office. Conversely, when the user is at the office, a technical or professional vocabulary is more likely than the household vocabulary. Therefore, the invention favors the appropriate vocabulary based on location context.

It will be appreciated by those of ordinary skill in the art that the present invention may be embodied in other specific forms without departing from the spirit or essential character thereof. The presently disclosed aspects are, therefore, considered in all respects to be illustrative and not restrictive.

What is claimed is:

1. A method of speech recognition, comprising:
receiving voice input;
associating a confidence measure with each of a set of stored patterns according to how closely the stored pattern matches the voice input;
acquiring location information; and
modifying at least one of the confidence measures based upon the location information.

2. The method of claim 1, wherein the voice input comprises a spoken label corresponding to an electronic address.

3. The method of claim 2, wherein the electronic address comprises a telephone number.

4. The method of claim 2, wherein the electronic address comprises an e-mail address.

5. The method of claim 2, wherein the electronic address comprises a Uniform Resource Locator.

6. The method of claim 1, wherein acquiring location information comprises the use of a Global Positioning System receiver.

7. The method of claim 1, wherein acquiring location information comprises the use of terrestrial cellular positioning.

8. The method of claim 1, wherein acquiring location information comprises examining the identification code of one or more base stations.

9. The method of claim 1, wherein acquiring location information comprises examining one of an area code, exchange code, or country code.

10. The method of claim 1, wherein the location information comprises the current location of a mobile communication device and each stored pattern corresponds to a stored telephone number.

11. The method of claim 10, wherein each stored telephone number corresponds to a location.

12. The method of claim 11, wherein the location information further comprises the distance between the current location of the mobile communication device and the location corresponding to each stored telephone number.

13. The method of claim 12, wherein modifying comprises increasing the confidence measure associated with each stored pattern for which the corresponding distance is less than a predetermined threshold.

14. The method of claim 12, wherein modifying comprises decreasing the confidence measure associated with each stored pattern for which the corresponding distance is greater than or equal to a predetermined threshold.

15. The method of claim 12, wherein modifying comprises increasing the confidence measure associated with each stored pattern for which the corresponding distance is less than a predetermined threshold and decreasing the confidence measure associated with each stored pattern for which the corresponding distance is greater than or equal to the predetermined threshold.

16. The method of claim 10, wherein modifying comprises increasing the confidence measure associated with each stored pattern for which a sub-part of the corresponding stored telephone number corresponds to a geographical region within which the current location of the mobile communication device lies.

17. The method of claim 16, wherein the sub-part is one of an area code, exchange code, or country code.

18. The method of claim 10, wherein modifying comprises decreasing the confidence measure associated with each stored pattern for which a sub-part of the corresponding stored telephone number does not correspond to a geographical region within which the current location of the mobile communication device lies.

19. The method of claim 10, wherein modifying comprises increasing the confidence measure associated with each stored pattern for which a sub-part of the corresponding stored telephone number corresponds to a geographical region within which the current location of the mobile communication device lies and decreasing the confidence measure associated with each stored pattern for which a sub-part of the corresponding stored telephone number does not correspond to the geographical region.

20. The method of claim 10, wherein the location information further comprises a record of previous telephone calls made using the mobile communication device and the corresponding locations from which the previous telephone calls were made.

21. The method of claim 20, wherein modifying comprises increasing the confidence measure associated with each stored pattern for which the corresponding stored telephone number has been called from the current location of the mobile communication device with a frequency exceeding a predetermined threshold, based upon the record of previous calls.

22. The method of claim 20, wherein modifying comprises decreasing the confidence measure associated with each stored pattern for which the corresponding stored telephone number has been called from the current location of the mobile communication device with a frequency less than or equal to a predetermined threshold, based upon the record of previous calls.

23. The method of claim 20, wherein modifying comprises increasing the confidence measure associated with each stored pattern for which the corresponding stored telephone number has been called from the current location of the mobile communication device with a frequency exceeding a predetermined threshold, based upon the record of previous calls, and decreasing the confidence measure associated with each stored pattern for which the corresponding stored telephone number has been called from the current location of the mobile communication device with a frequency less than or equal to the predetermined threshold.

24. The method of claim 10, wherein the location information further comprises user preferences identifying, for at least one designated location, at least one of the stored telephone numbers that is most likely to be called from the designated location.

25. A method for voice-dialing in a mobile communication device, comprising:
receiving voice input comprising a spoken label corresponding to a desired telephone number;
associating a confidence measure with each of a set of stored patterns according to how closely the stored pattern. matches the voice input, each pattern corresponding to a stored telephone number;
computing the difference between the greatest and next-to-greatest confidence measures;
dialing the stored telephone number corresponding to the greatest confidence measure if the difference exceeds a predetermined threshold; and
acquiring location information comprising the current location of the mobile communication device, modifying the confidence measures corresponding to one or more of the stored telephone numbers based upon the location information, and dialing the stored telephone number corresponding to the resulting greatest confidence measure if the difference is less than the predetermined threshold.

26. The method of claim 25, wherein acquiring location information comprises the use of a Global Positioning System receiver.

27. The method of claim 25, wherein acquiring location information comprises the use of terrestrial cellular positioning.

28. The method of claim 25, wherein acquiring location information comprises examining the identification code of one or more base stations.

29. The method of claim 25, wherein each stored telephone number corresponds to a location, and the location information further comprises the distance between the current location of the mobile communication device and the location corresponding to each stored telephone number.

30. The method of claim 29, wherein modifying comprises increasing the confidence measure associated with each stored pattern for which the corresponding distance is less than a predetermined threshold.

31. The method of claim 29, wherein modifying comprises decreasing the confidence measure associated with each stored pattern for which the corresponding distance is greater than or equal to a predetermined threshold.

32. The method of claim 29, wherein modifying comprises increasing the confidence measure associated with each stored pattern for which the corresponding distance is less than a predetermined threshold and decreasing the confidence measure associated with each stored pattern for which the corresponding distance is greater than or equal to the predetermined threshold.

33. The method of claim 25, wherein modifying comprises increasing the confidence measure associated with each stored pattern for which a sub-part of the corresponding stored telephone number corresponds to a geographical region within which the current location of the mobile communication device lies.

34. The method of claim 33, wherein the sub-part is one of an area code, exchange code, or country code.

35. The method of claim 25, wherein modifying comprises decreasing the confidence measure associated with each stored pattern for which a sub-part of the corresponding stored telephone number does not corresponds to a geographical region within which the current location of the mobile communication device lies.

36. The method of claim 25, wherein modifying comprises increasing the confidence measure associated with each stored pattern for which a sub-part of the corresponding stored telephone number corresponds to a geographical region within which the current location of the mobile communication device lies and decreasing the confidence measure associated with each stored pattern for which a sub-part of the corresponding stored telephone number does not correspond to the geographical region.

37. The method of claim 25, wherein the location information further comprises a record of previous telephone calls made using the mobile communication device and the corresponding locations from which the previous telephone calls were made.

38. The method of claim 37, wherein modifying comprises increasing the confidence measure associated with each stored pattern for which the corresponding stored telephone number has been called from the current location of the mobile communication device with a frequency exceeding a predetermined threshold, based upon the record of previous calls.

39. The method of claim 37, wherein modifying comprises decreasing the confidence measure associated with each stored pattern for which the corresponding stored telephone number has been called from the current location of the mobile communication device with a frequency less than or equal to a predetermined threshold, based upon the record of previous calls.

40. The method of claim 37, wherein modifying comprises increasing the confidence measure associated with each stored pattern for which the corresponding stored telephone number has been called from the current location of the mobile communication device with a frequency exceeding a predetermined threshold, based upon the record of previous calls and decreasing the confidence measure associated with each stored pattern for which the corresponding stored telephone number has been called from the current location of the mobile communication device with a frequency less than or equal to the predetermined threshold.

41. The method of claim 25, wherein the location information further comprises user preferences identifying, for at least one designated location, at least one of the stored telephone numbers that is most likely to be called from the designated location.

42. A communication device, comprising:
a speech recognition circuit that provides confidence measures;
circuitry for acquiring location information; and
logic for modifying the confidence measures based on the location information.

43. The communication device of claim 42, wherein the circuitry for acquiring location information comprises a Global Positioning System receiver.

44. The communication device of claim 42, wherein the circuitry for acquiring location information derives at least a portion of the location information using terrestrial cellular positioning.

45. The communication device of claim 42, wherein the circuitry for acquiring location information derives at least a portion of the location information based on the identification code of one or more base stations.

46. The communication device of claim 42, wherein the circuitry for acquiring location information derives at least a portion of the location information from one of an area code, exchange code, or country code.

47. A communication device, comprising:
means for recognizing speech and producing associated confidence measures;
means for acquiring location information; and
means for modifying the confidence measures based upon the location information.

48. The communication device of claim 47, wherein the means for acquiring location information comprises a Global Positioning Receiver.

49. The communication device of claim 47, wherein the means for acquiring location infor mation comprises terrestrial cellular positioning.

50. The communication device of claim 47, wherein the means for acquiring location information comprises the identification code of one or more base stations with which the communication device is in communication.

51. The communication device of claim 47, wherein the means for acquiring location information comprises one of an area code, exchange code, or country code.

52. A mobile communication device, comprising:
a microphone;
a speech recognition circuit that receives input from the microphone and provides confidence measures;
an RF transceiver;
an antenna electrically connected to the RF transceiver;
a circuit for acquiring location information;
an input device;
a memory;
a display;
a microprocessor;
a data bus through which the microprocessor communicates with the speech recognition circuit, the RF transceiver, the circuit for acquiring location information, the input device, the memory, and the display; and
program instructions stored in the memory and executable within the microprocessor for modifying the confidence measures based on the location information.
